(19) United States
(12) Patent Application Publication
(10) Pub. No.: US 2009/0322691 A1
(43) Pub. Date: Dec. 31, 2009

(54) METHOD AND SYSTEM FOR ADJUSTING ORIENTATIONS OF USER INTERFACES BY DETECTING GRAVITY ACCELERATION VALUES

(75) Inventor: YI-LIN CHIU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/268,420

(22) Filed: Nov. 10, 2008

(30) Foreign Application Priority Data
Jun. 26, 2008 (CN) 200810302338.7

(51) Int. Cl. G06F 3/041; H04B 1/38

(52) U.S. Cl. 345/173; 455/566

(57) ABSTRACT

A method and system for adjusting orientations of user interfaces on a portable electronic device are provided. The method includes detecting coordinates of user contacted points of a touch panel of the portable electronic device, generating unlock signals of user inputs corresponding to the detected coordinates, detecting a value of gravity acceleration of the portable electronic device by a gravity sensor, and adjusting orientations of user interfaces of applications upon determining that the detected value of the gravity acceleration of the portable electronic device is less than about zero.

### BACKGROUND

1. Field of the Invention

Embodiments of the present disclosure relate to orientations adjustment, and more particularly to a method and a system for adjusting orientations of user interfaces by detecting gravity acceleration values.

2. Description of related art

Many cellular phones are designed for hands-on use with images having the same orientation as the cellular phones, such as top of the image oriented with top of the cellular phone. However, for the cellular phones utilized touch panels for providing an improved input means, without typical keypad-style input, it is difficult to recognize the top of the phone upon grabbing the phone from a purse. In this situation, the images displayed by the touch panel would be appear upside down to the users.

In addition, a related cellular phone includes only one touch panel installed in a first surface of the cellular phone. Thus, the users have to overturn of the cellular phone if the first surface assembled with the touch panel does not face up when holding the cellular phone in one hand.

Accordingly, a method and a system for adjusting orientations of user interfaces in response to the orientations of a portable electronic device are called for in order to overcome the limitations described.

### BRIEF DESCRIPTION OF THE DRAWINGS

FIG. 1 is a block diagram of a first embodiment of a system for adjusting orientations of user interfaces by detecting a value of the gravity acceleration;

FIG. 2 is an isometric view of the electronic device according to the first embodiment;

FIG. 3 is an isometric view of an electronic device according to a second embodiment; and

FIG. 4 is a flowchart of a third embodiment of a method for adjusting orientations of user interfaces by detecting a value of the gravity acceleration.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus. As used herein, the term “detecting gravity” is defined as detecting a value of the gravity acceleration (hereinafter referred to as “the value of g”) of an object. The value of “g” of an object may be measured and/or adjusted according to an orientation of the object relative to a predefined axis system. The value of “g” may comprise positive or negative values depending on the orientation of the object.

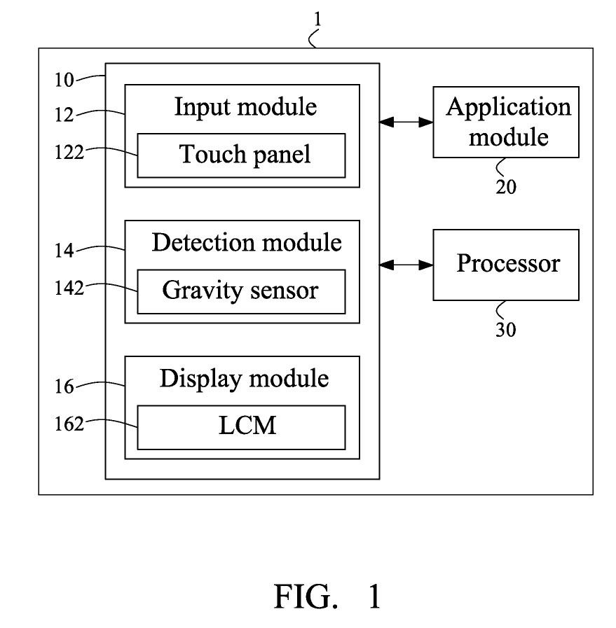

FIG. 1 is a block diagram of a first embodiment of a system 10 for adjusting orientations of user interfaces (hereinafter “the system 10”) by detecting the value of “g.” An electronic device 1, such as a mobile phone, includes the system 10, an application module 20 having profiles of the applications executed on the electronic device 1, and a processor 30 for executing the system 10 and the application module 20. Portable and non-portable electronic devices other than the mobile phone shown here, such as notebook computers and personal digital assistants (PDAs), for example, may equally utilize the system 10, without departing from the spirit of the disclosure.

In a first embodiment, the system 10 includes an input module 12, a detection module 14 and a display module 16, in addition to other hardware and software components of the system 10. The input module 12 is configured for receiving user inputs as will be further defined below. The detection module 14 is configured for detecting the value of “g” of the electronic device 1 after the electronic device 1 is unlocked by the user inputs. The display module 16 is configured for adjusting orientations of user interfaces of applications executed on the electronic device 1 upon determining that the detected value of “g” of the electronic device 1 is less than about zero.

The input module 12 includes a touch panel 122 for detecting coordinates of contacted points of user inputs. It is to be noted that the user inputs include contacts made by a stylus or fingers to the touch panel 122. In addition, the input module 12 is also configured for generating unlock signals corresponding to successful authorization of the authentication procedure. If an inputted password matches a predefined password, unlock signals are generated to unlock the touch panel 122 for receiving user inputs. It is to be noted that the input module 12 acquires the predefined password from the application module 20 of the electronic device 1.

The detection module 14 includes at least one gravity sensor 142. Upon receiving the unlock signals sent from the input module 12, the detection module 14 begins to continuously detect the value of “g” of the electronic device 1 by the gravity sensor 142 for a predefined interval after the touch panels 122 is unlocked. In the first embodiment, the interval have default value. For example, if the default value of the interval is 5 seconds, the detection module 14 detects the value of “g” of the electronic device 1 every 5 seconds. It is to be noted that the value of the interval may be modified according to actual requirements. Depending on the embodiment, the detection module may comprise an accelerometer, a motion sensor, or some combination thereof, but the present disclosure is not limited thereto.

In the first embodiment, the gravity sensor 142 outputs a positive value of “g” value, such as 9.8 m/s2 (meters per second-squared), upon detecting that the electronic device 1 is positioned in an up-down direction. In addition, the gravity sensor 142 outputs a negative value of “g” value, such as −9.8 m/s2, upon detecting that the electronic device 1 is tilted to have an orientation of about 180 degrees along the predefined axis system. The detected value of “g” is then transmitted to the display module 16.

The display module 16 includes a liquid crystal display module (LCM) 162. The images showing the user interfaces of the applications executed on the electronic device 1 are transmitted from the application module 20 to the display module 16 so as to display the images on the LCM 162. The display module 16 determines whether or not to adjust orientations of the user interfaces according to the detected value of “g” provided by the detection module 14.

Upon determining that the detected value of “g” is less than about zero, the display module 16 adjusts orientations of the user interfaces. In the first embodiment, the orientations of the user interfaces are rotated approximately 180 degrees, but the disclosure is not limited thereto.

Upon determining that the detected value of “g” is greater than about zero, the display module 16 is configured for simply displaying the images regarding the user interfaces retrieved from the application module 20.

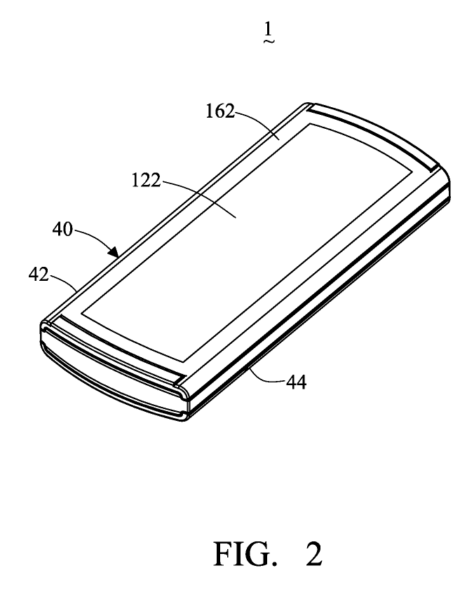

FIG. 2 is an isometric view of the electronic device 1 according to the first embodiment. The housing 40 includes a first surface 42 and a second surface 44 opposite to the first surface 42. The LCM 162 and the touch panel 122 are assembled to the first surface 42 of the electronic device 1. Thus, the LCM 162 is capable of displaying the user interfaces of the applications executed on the electronic device 1 and the touch panel 122 is capable of detecting coordinates of contacted points of the user inputs.

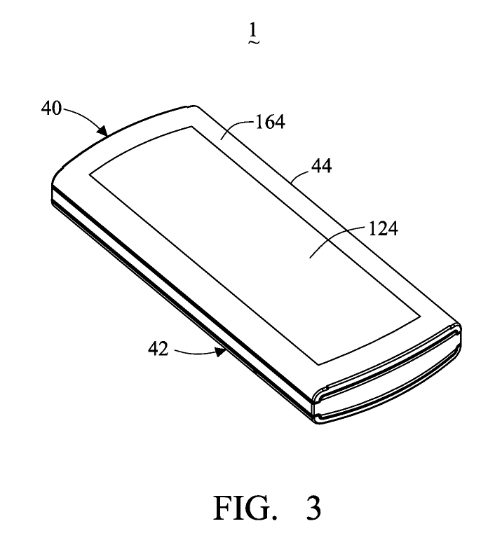

FIG. 3 is an isometric view of an electronic device 1 according to a second embodiment. The modules and corresponding operations of the electronic device 1 are the same as that of the first embodiment mentioned above except with respect to the additional LCM and touch panel assembled to the second surface 44 of the electronic device 1. As shown in FIG. 3, a second LCM 164 and a second touch panel 124 are assembled to the second surface 44. Thus, both the first surface 42 and the second surface 44 are capable of displaying the user interfaces of the applications executed on the electronic device 1 and detecting coordinates of contacted points of the user inputs.

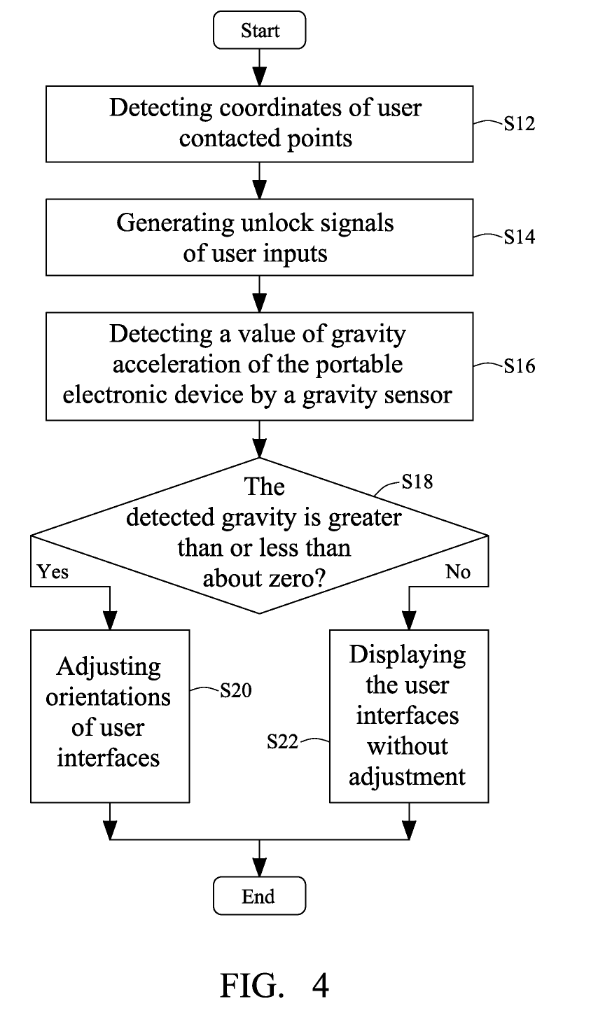

FIG. 4 is a flowchart of a third embodiment of a method for adjusting orientations of user interfaces by detecting the value of “g.” The method of FIG. 4 may used for adjusting orientations of user interfaces in response to the orientations of the electronic device 1. Depending on the embodiment, additional blocks may be added or deleted and the blocks may be executed in order other than that described.

In block S12, the input module 12 detects coordinates of contacted points of user inputs. In block S14, the input module 12 generates unlock signals of user inputs upon determining an inputted password matches a predefined password. The unlock signals are generated for unlocking the touch panel 122.

In block S16, the detection module 14 detects the value of “g” of the electronic device 1 by the gravity sensor 142. In block S18, the display module 16 determines if the detected value of “g” is greater than or less than about zero. If the detected value of “g” is less than about zero, in block S20, the display module 16 adjusts orientations of user interfaces of applications executed on the portable electronic device 1.

If the detected value of “g” is greater than about zero, in block S22, the display module 16 displays the user interfaces of the applications without adjustment.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A system for adjusting orientations of user interfaces on a portable electronic device, the system comprising:
an input module for detecting coordinates of user contacted points of a touch panel of the portable electronic device and for generating unlock signals for unlocking the touch panel in response to the detected coordinates;
a detection module for detecting a value of gravity acceleration of the portable electronic device by a gravity sensor in the portable electronic device after the touch panel being unlocked; and
a display module for adjusting orientations of user interfaces of applications executed on the portable electronic device upon determining that the detected value of the gravity acceleration of the portable electronic device is less than about zero.

2. The system as claimed in claim 1, wherein the display module is configured for displaying the user interfaces of the applications upon determining that the detected value of the gravity acceleration of the portable electronic device is greater than about zero.

3. The system as claimed in claim 1, wherein the orientations of the user interfaces are rotated approximately 180 degrees.

4. The system as claimed in claim 1, wherein the display module comprises a first liquid crystal display module (LCM) for displaying the user interfaces of the applications.

5. The system as claimed in claim 4, wherein the input module comprises a first touch panel for detecting coordinates of contacted points of the user inputs.

6. The system as claimed in claim 5, wherein the portable electronic device comprises a housing with a first surface and a second surface opposite to the first surface, the first LCM and the first touch panel being assembled to the first surface of the housing.

7. The system as claimed in claim 6, wherein the input module further comprises a second LCM, the display further comprises a second touch panel, the second LCM and the second touch panel being assembled to the second surface of the housing.

8. The system as claimed in claim 1, wherein the detection module comprises an accelerometer and/or a motion sensor.

9. A computer-implemented method for adjusting orientations of user interfaces on a portable electronic device, the method comprising:
detecting coordinates of user contacted points of a touch panel of the portable electronic device;
generating unlock signals of user inputs corresponding to the detected coordinates for unlocking the touch panel;
detecting a value of gravity acceleration of the portable electronic device by a gravity sensor after the touch panel being unlocked; and
adjusting orientations of user interfaces of applications executed on the portable electronic device upon determining that the detected value of the gravity acceleration of the portable electronic device is less than about zero.

10. The method as claimed in claim 9, wherein the method further comprises: displaying the user interfaces of the applications upon determining that the detected value of the gravity acceleration of the portable electronic device is greater than about zero.

11. The method as claimed in claim 10, wherein the unlock signals of user inputs are generated upon determining an inputted password matches a predefined password.

12. The method as claimed in claim 10, wherein the orientations of the user interfaces are rotated approximately 180 degrees.

13. A computer-readable medium for adjusting orientations of user interfaces on a portable electronic device, the computer-readable medium having stored thereon instructions that, when executed by an electronic device, cause the electronic device to:
detect coordinates of user contacted points of a touch panel of the portable electronic device;
generate unlock signals of user inputs corresponding to the detected coordinates for unlocking the touch panel;
detect a value of gravity acceleration of the portable electronic device by a gravity sensor after the touch panel being unlocked; and
adjust orientations of user interfaces of applications executed on the portable electronic device upon determining that the detected value of the gravity acceleration of the portable electronic device is less than about zero.

14. The computer-readable medium as claimed in claim 13, wherein the instructions further cause the electronic device to:
display the user interfaces of the applications upon determining that the detected value of the gravity acceleration of the portable electronic device is greater than about zero.

15. The computer-readable medium as claimed in claim 14, wherein the unlock signals of user inputs are generated upon determining an inputted password matches a predefined password.

16. The computer-readable medium as claimed in claim 14, wherein the orientations of the user interfaces are rotated approximately 180 degrees.
